(19) United States
(12) Patent Application Publication
(10) Pub. No.: US 2007/0088643 A1
(43) Pub. Date: Apr. 19, 2007

(54) Method of buying property with a lease option contract

(75) Inventor: Warren Doi, San Francisco, CA (US)

Correspondence Address: WILSON SONSINI GOODRICH & ROSATI, 650 PAGE MILL ROAD, PALO ALTO, CA, 94304-1050, US

(73) Assignee: Home Option, Inc., San Francisco, CA (US)

(21) Appl. No.: 11/549,081

(22) Filed: Oct. 12, 2006

Related U.S. Application Data
(60) Provisional application No. 60/727,597, filed on Oct. 17, 2005.

(51) Int. Cl. G06Q 40/00

(52) U.S. Cl. 705/35

(57) ABSTRACT

The instant invention facilitates home purchasing for parties that desire a lease-to-own option for a home purchase. The instant invention provides the Future Home Buyer the choice to buy the home of their choice on the open market by entering into a lease option agreement via the operation of the instant invention.

### CROSS-REFERENCE

This application claims priority to the U.S. Provisional Application No. 60/727,597 filed Oct. 17, 2005 entitled “A Method of Buying Property with a Lease Option Contract” which is hereby incorporated by reference herein in its entirety.

### BACKGROUND OF THE INVENTION

Real Estate

Throughout recent history in the United States, the most stable sector of real estate has been the housing market. The location of the property and the dynamics of the local economic conditions primarily determine real estate values. Given the cyclical nature of the U.S. economy, commercial real estate (e.g., office, retail, industrial, multi-family, hotels) experiences significant periods of expansion and contraction. In contrast, the Single Family Residence (SFR) market has experienced a much more stable growth trend related directly to the growing population and the concomitant increasing demand for housing. While the short-term and medium-term outlooks for the housing market may depend on interest rates and the course of the economy, the longer-term prospect for the value of housing real estate is tied far more to demographic trends.

Most individuals or families face two choices for housing in the SFR market: renting or buying. In general, the benefits of buying a home outweigh the disadvantages of home ownership, and most people prefer home ownership over renting, in part due to the historical appreciation of SFR real estate. Nevertheless, many people are forced into a category of “have-nots” (renters) versus “haves” (housing buyers) due to a lack of money, knowledge, and/or access to the home buying market.

Regional High Growth

Regional factors significantly influence real estate value. High growth/appreciation regions can be identified with respect to the housing real estate market. Rising real estate markets are associated with:
(1) strong local economic conditions (e.g., areas of job growth, stable/expanding industries, diversified economies, pro-growth initiatives, favorable city/county governments);
(2) a suitable affordability index (i.e., the ratio of regional average incomes to local housing costs);
(3) stable housing prices poised for appreciation (i.e., high growth areas which have not yet experienced hyper-growth or are not in an overly appreciated market);
(4) acceptable home-building-permit to rental-population ratio; and/or
(5) other factors.

Demographic changes may also predict high growth regions. For example, retiring Baby Boomers may potentially create enormous regional population shifts. Surveys have found that Florida and Arizona are the top destinations for those planning to relocate in retirement. Even though the top destination states for relocating upon retirement are Florida and Arizona, also included are North and South Carolina, Tennessee, Texas, Virginia, and Colorado.

Financing

Most prospective home-owners require a mortgage-backed loan to purchase property. Myriad providers may furnish home loans, but conventional financing for housing real estate is limited to strict underwriting guidelines. These guidelines must conform to standards set forth by the secondary market (e.g., Fannie Mae, Freddie Mac, and other mortgage-backed securities). These lending institutions limit home buying only to those in the top segments of the standard credit scoring system. In part, these lending guidelines typically require a two year history of employment in the same line of business, a requirement that can exclude otherwise well-qualified buyers. Furthermore, millions of hard working families simply do not have the thousands or tens of thousands of dollars required for a down payment along with the potential additional thousands required for closing costs. These realities, and others, force many families to rent when they would prefer to buy. A huge demand exists for providing new financial vehicles and value-added services, and related business methods, to help working families, those starting new careers, as well as others incapable of qualifying under traditional financing guidelines, to acquire part of the American Dream: home ownership.

REITs

Real Estate Investment Trusts (REITs) were originally designed as a means for smaller investors to invest in the real estate market, and potentially garner attractive returns from these investments. REITs are required to distribute 90% of all retained earnings to investors each year. In general, this forces REITs to focus on commercial space, such as retail, industrial, apartment buildings, storage or office space. It is difficult for REITs to work in the SFR space as optimal exploitation of this market would be tend to be characterized by high degree of retained earnings together with a build up of equity.

Further, traditional (non-REIT) real estate investors in the SFR market are not interested in investments that have a capped earning realization. Thus, a need exists to form REITs capable of operating in the SFR market where unlimited earning potential is offset by a more stable return on investment.

Lease-Options

Lease options are rare in the real estate market. They are generally only known in two markets: (1) as a rental inducement where the landlord has very little expectation of the tenant being able to qualify to purchase the property, and thus just charges additional rent; and (2) when there are very high interest rates such that very few buyers qualify to buy. An example of the latter was the 1970s when interest rates were very high and it was difficult to transfer ownership in property; therefore lease-options provided such a means. Now, given the relative ease of qualifying for a home loan for many prospective buyers, the use of lease options to transfer property, rather than just effectively increase the rent, is rare. Further, many prospective Future Home Buyers may just wait for a change in circumstances and/or credit rating so that they can qualify for a loan before purchasing a SFR. However, given the methods of the instant invention, there is no reason for such prospective Future Home Buyers to wait.

### SUMMARY OF THE INVENTION

In a first aspect, the invention features a method for a Future Home Buyer to become resident in a single family residence wherein the method comprises the steps of (1) the Future Home Buyer selecting the single family residence from among those that are for sale; (2) the Future Home Buyer directing a third party to purchase the SFR; (3) the third party purchasing the SFR; and (4) the third party leasing the SFR to the Future Home Buyer for a lease period; wherein the Future Home Buyer has an option to purchase the SFR from the third party after the lease period. Although these steps are set forth sequentially, the Future Home Buyer may proceed through the steps individually at her/his own pace; it is not necessary that the Future Home Buyer be in the program at the start and may join at any time. In general, the lease period is set by contract, possibly as a range, and followed by the Conversion Point where the Future Home Buyer elects to terminate the lease and begin the process, including escrow, of purchasing the SFR from the third party. In some preferred embodiments, the third party is an entity referred to herein as The Company. In other preferred embodiments, the third party is an entity referred to herein as the Company Investor. In further preferred embodiments, the third party is a REIT. In still other preferred embodiments, the Future Home Buyer pays to the third party a monthly payment (similar to rent or a lease payment) wherein a percentage of the monthly payment is used as Purchase Credit after the lease period and during the final escrow. In still further embodiments, the Future Home Buyer exercises the option to purchase the SFR from the third party after becoming resident in the property and where the option is exercised after the lease period and then the future Home Buyer proceeds to purchase the SFR. In additional preferred embodiments, the Purchase Credit is used: (1) towards a down payment when the Future Home Buyer finances the Future Home Buyer's purchase of the SFR; (2) towards payment of the Future Home Buyer's closing costs when the Future Home Buyer finances the Future Home Buyer's purchase of the SFR; (3) towards payment of the Future Home Buyer's real estate agent's commission when the Future Home Buyer finances the Future Home Buyer's purchase of the SFR; and/or (4) towards payment of any cost associated with an escrow following a conversion point following the Future Home Buyer's exercise of the option to purchase the SFR. In some preferred embodiments, a computer is used to match available funds of the third party for purchasing the SFR at the Future Home Buyer's direction. In additional preferred embodiments, the price paid for the SFR by the third party serves as a basis for the price paid, or to be paid, by the Future Home Buyer upon the latter's purchase; and that the price paid by the Future Home Buyer is determined by a contractually set appreciation rate based on the price paid by the third party.

In another aspect, the invention features a method for an investor to invest in a single family residence wherein the method comprises the steps of: (1) selecting a Future Home Buyer; (2) the Future Home Buyer selecting a SFR for sale; (3) the investor buying the SFR; (4) the investor leasing the SFR to the Future Home Buyer for a lease period, and the Future Home Buyer having an option to purchase the SFR from the investor after the lease period. Although these steps are set forth sequentially, each investor and Future Home Buyer may proceed through the steps individually at their own pace and order. In some preferred embodiments, this method comprises having The Company, as defined herein, be featured as the investor. In other preferred embodiments, the invention features having a Company Investor, as defined herein, as the investor. In still other preferred embodiments, the method comprises having a REIT be the investor. In further preferred embodiments, the Future Home Buyer pays to the investor a monthly payment during the lease period, similar to rent or to a lease payment, wherein a percentage of the Future Home Buyer's the monthly payment is set aside as a Purchase Credit when the Future Home Buyer purchases the SFR. In additional preferred embodiments, the Purchase Credit is used: (1) towards a down payment when the Future Home Buyer finances the Future Home Buyer's purchase of the SFR; (2) towards payment of the Future Home Buyer's closing costs when the Future Home Buyer finances the Future Home Buyer's purchase of the SFR; (3) towards payment of the Future Home Buyer's real estate agent's commission when the Future Home Buyer finances the Future Home Buyer's purchase of the SFR; and/or (4) towards payment of any cost associated with an escrow following a conversion point following the Future Home Buyer's exercise of the option to purchase the SFR. In still further preferred embodiments, the Future Home Buyer exercises the option to purchase the SFR at the end of the lease period and then purchases the SFR. In additional preferred embodiments, the price paid for the SFR by the third party serves as a basis for the price paid, or to be paid, by the Future Home Buyer upon the latter's purchase; and that the price paid by the Future Home Buyer is determined by a contractually set appreciation rate based on the price paid by the third party.

In another aspect, the invention features a method for one or more investors to invest in a single family residence wherein the method comprises the steps of: (1) selecting a plurality of Future Home Buyers to participate in a LTP Program (as described herein); (2) then each of the plurality of Future Home Buyers selecting a corresponding SFR of her/his/their choice that is for sale; (3) then the investor(s) purchasing each corresponding SFR for each Future Home Buyer of the plurality of Future Home Buyers; (4) the investor(s) leasing each of the corresponding SFRs to each of the Future Home Buyers for a lease period; and (5) each of the Future Home Buyers having an option to purchase the SFR from the investor after the lease period. Although these steps are set forth sequentially, each Future Home Buyer may proceed through the steps individually at their own pace; it is not necessary that all Future Home Buyers be selected at the start and they may be added during the operation. Similarly, all Future Home Buyers need not select a SFR before any are bought, etc. In some preferred embodiments, the method features the situation wherein the investor(s) are The Company, as defined herein. In other preferred embodiments, the method features the situation wherein the investor(s) are Company Investors, as defined herein. In still other preferred embodiments, the method features a REIT as the investor(s). In further preferred embodiments, the invention features each Future Home Buyer paying the investor(s) a monthly payment (similar to rent or a lease payment) for his/hers/their SFR, wherein a part of each of the Future Home Buyers' monthly payment is individually set aside as a Purchase Credit to that Future Home Buyer when the Future Home Buyer purchases the SFR. In additional preferred embodiments, the Purchase Credit is used: (1) towards a down payment when the Future Home Buyer finances the Future Home Buyer's purchase of the SFR; (2) towards payment of the Future Home Buyer's closing costs when the Future Home Buyer finances the Future Home Buyer's purchase of the SFR; (3) towards payment of the Future Home Buyer's real estate agent's commission when the Future Home Buyer finances the Future Home Buyer's purchase of the SFR; and/or (4) towards payment of any cost associated with an escrow following a conversion point following the Future Home Buyer's exercise of the option to purchase the SFR. In still further preferred embodiments, one or more of the Future Home Buyers exercises the option to purchase the corresponding SFR in which the Future Home Buyer resides at the end of the lease period. In additional embodiments, the method relates the price paid by each Future Home Buyer to the price paid for the corresponding SFR by the investor(s) by a contractually set appreciation rate.

In still another aspect, the invention features a method for a plurality of Future Home Buyers to reside in plurality of a single family residences comprising the steps of: (1) each of the Future Home Buyers selecting a corresponding single family residence that is for sale; (2) each of the Future Home Buyers directing a third party to purchase the corresponding SFR; (3) one or more third parties purchasing the corresponding SFR for each of the Future Home Buyers; and (4) third party(s) leasing each of the corresponding SFR selected by a Future Home Buyer to the selecting Future Home Buyers for a lease period; wherein each of the Future Home Buyers has an option to purchase the corresponding SFR from the third party(s) after the lease period. Although these steps are set forth sequentially, each Future Home Buyer may proceed through the steps individually, at their own pace; it is not necessary that all Future Home Buyers be selected at the start and they may be added during the operation. Similarly, all Future Home Buyers need not select a SFR before any are bought, etc. In some preferred embodiments, the method features the situation wherein the third party is The Company, as defined herein. In other preferred embodiments, the method features the situation wherein the third party(s) are Company Investors, as defined herein. In still other preferred embodiments, the method features a REIT as the third party(s). In further preferred embodiments, the invention features each Future Home Buyer paying the third party(s) a monthly payment (similar to rent or a lease payment) for his/hers/their SFR, wherein a part of each of the Future Home Buyers' monthly payment is individually set aside as a Purchase Credit to that Future Home Buyer when the Future Home Buyer purchases the SFR. In additional preferred embodiments, the Purchase Credit is used: (1) towards a down payment when the Future Home Buyer finances the Future Home Buyer's purchase of the SFR; (2) towards payment of the Future Home Buyer's closing costs when the Future Home Buyer finances the Future Home Buyer's purchase of the SFR; (3) towards payment of the Future Home Buyer's real estate agent's commission when the Future Home Buyer finances the Future Home Buyer's purchase of the SFR; and/or (4) towards payment of any cost associated with an escrow following a conversion point following the Future Home Buyer's exercise of the option to purchase the SFR. In still further preferred embodiments, one or more of the Future Home Buyers exercises the option to purchase the corresponding SFR in which the Future Home Buyer resides at the end of the lease period. In additional embodiments, the method relates the price paid by each Future Home Buyer to the price paid for the corresponding SFR by the third party(s) by a contractually set appreciation rate.

In an additional embodiment of any of the above aspects, the instant invention is advertised, and the advertisements may include printed ads, audio ads, such as on the radio, and/or visual ads, such as on television or on a billboard. In another additional aspect, the invention features advertising the instant invention to select Future Home Buyer(s). Again, the advertisements may include printed ads, audio ads, such as on the radio, and/or visual ads, such as on television or on a billboard.

In another additional embodiment of any of the above aspects, the Future Home Buyer's interest in the SFR is recorded against the SFR's title.

In yet another additional embodiment of any of the above aspects, a computer is used to match available funds of the third party for purchasing SFRs, or to maintain a list of current Future Home Buyers, or to maintain a list of eligible properties.

### INCORPORATION BY REFERENCE

All publications and patent applications mentioned in this specification, if any, are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1, 2: FIGS. 1 and 2 represent an overview of one embodiment of the process or method of the instant invention. These figures represent one possible set and sequence of events, but other sequences of events are contemplated by the instant invention, and not all events are necessary, or in some circumstances, desirable, to practice the instant invention. For example, the process may be initiated by a Future Home Buyer rather than the real estate agent depicted in FIG. 1. This particular flow chart partners Century 21® (“C21”) with the operator of the instant invention, but other partners are possible and contemplated within the instant invention.

FIG. 3: FIG. 3 represents an underwriting report based on Fannie Mae guidelines and generated using Fannie Mae's desktop underwriter for a hypothetical Future Home Buyer.

FIG. 4: FIG. 4 represents an expected investment portfolio for an LLC utilizing some features of the instant invention.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

(a) Definitions

As used herein, the term “The Company” refers to the business organization that operates the instant invention. In some preferred embodiments, The Company is a corporation. In other preferred embodiments, The Company is an LLC. Other business structures known to those of skill in the art, including partnerships and sole proprietorships, are also contemplated and encompassed by the instant invention.

In the instant invention's current embodiment, The Company is Home Option Investments, Inc. (“Home Option”). However, other business entities, including companies, corporations, partnerships, sole proprietorships and/or LLCs not yet formed, may operate the instant invention. Although some of the examples of the instant invention described herein include activities of Home Option, this should not be construed as limiting the instant invention in any manner to only the activities of Home Option. An individual investor may also use the instant invention; in preferred embodiments, an individual investing in such a manner invests in at least two SFRs for at least two Future Home Buyers.

As used herein, the term “Future Home Buyer” (“FHB”) refers to a participant in The LTP Program of the instant invention (defined below and herein). The Future Home Buyer may participate in The LTP Program by one or more of the following: entering into an agreement with The Company, then selecting a SFR property, selecting a SFR property then entering into an agreement with The Company, paying The Company a fee, facilitating the purchase of the SFR property by The Company (or the Company Investor), leasing the property in question from The Company (or the Company Investor), and having the option of purchasing, and in preferred embodiments, purchasing the property in question from The Company (or the Company Investor).

As used herein, the term “Conversion Point” refers to the action under a lease option contract wherein the Future Home Buyer elects to purchase the housing property from The Company (or the Company Investor). The timing of selecting the Conversion Point is preferably and primarily under the control of the Future Home Buyer within guidelines established by The Company in the lease option contract.

As used herein, the term “Purchase Credit” refers to the portion of the monthly payment that is credited towards the down payment, closing costs, and/or other costs or payments at the Close of Escrow after the Conversion Point associated with the Future Home Buyer. In other embodiments of the instant invention, the Purchase Credit may be applied for other purposes as long as such purposes benefit the Future Home Buyer.

As used herein, the term “The LTP Program” refers to the method of the instant invention where the selection, leasing, option to purchase, and potentially the ultimate purchase of SFR property are at least at some point or points facilitated by The Company. In some embodiments, The Company matches the prospective Future Home Buyers with a prospective Investor(s) (also known as the Company Investor). In other embodiments, The Company, the Company Investor, or an investor at the direction of The Company, directly funds the purchase of the SFR.

As used herein, the terms “Single Family Residence” or “SFR” refers to a housing property intended for housing a single family, individual or group of individuals, including a detached house; a part of a multiplex (e.g., half of a duplex); a condominium; an apartment; or a residence in a co-op, retirement or other housing community. A SFR may also be referred to herein as a “house” or a “home.”

As used herein, the term “Company Investor” refers to an individual (or individuals) that have chosen to invest money and/or other forms of capital towards the operation of the instant invention, either directly in The Company or at the direction of The Company, or a mixture of the two. In some embodiments, this capital may be invested directly in The Company, while in other embodiments the capital is primarily invested in the subject SFR or a mixture of the two. Thus, such an investor may be a passive participant in the instant invention, or may actively take some part in the purchase and lease of the SFR property. In some preferred embodiments, the Company Investor may not directly invest funds and/or capital in The Company but may invest directly in the SFR purchase. In other preferred embodiments, the Company Investor is a business entity such as a partnership, an LLC or a corporation.

As used herein, the term “lease period” refers to a period set by The Company or the Company Investor(s) after negotiation with or notice to the Future Home Buyer after The Company or the Company Investor(s) buys the SFR property before the Future Home Buyer can exercise the Future Home Buyer's option to buy the SFR property and prior to when the Future Home Buyer exercises the option to buy. In other words, the lease period is the amount of time before the Conversion Point can be triggered by the Future Home Buyer, or before the Future Home Buyer can exercise their option to begin process of purchasing the property and entering the final escrow. In preferred embodiments, this lease period is about one year, about two years, or about three years. In other preferred embodiments, the lease period may also be a range, e.g., six months to one year, one year to two years, or one year to three years. In preferred embodiments, the lease period is anywhere from eight months to sixty months, inclusive. Additionally, when a reference to an aspect of the invention lists a range of individual numbers, as for a non-limiting example, ‘six months to three years, inclusive,’ it is intended to be equivalent to listing every number in the range individually, and additionally it should be understood that any given number within the range may be included in the claim individually.

The phrase “during said Future Home Buyer's purchase” as used herein refers to any point within the final escrow of the purchase of the SFR by the Future Home Buyer. In preferred embodiments, it refers to the final transfer of funds to purchase the house at the close of escrow. In other embodiments, in refers to any point within the final escrow period, including the initiation of the escrow period.

(b) Description

The instant invention is primarily directed at facilitating a home purchase for families, individuals or others that do not qualify to buy a home, although it may be used for any individual or group of individuals desiring a lease-to-own option for a home purchase. The instant invention provides an outstanding benefit by enabling the Future Home Buyer to choose the home of her/his/their choice on the open market, without regard to whether the seller is offering or desires to offer a lease-option or lease-to-own arrangement, and to enter into an lease option agreement on that exact home.

In one embodiment, in an initial first step of practicing the instant invention, the prospective Tenant/Client, i.e., the Future Home Buyer, is provided with an overview of the process. If a Future Home Buyer elects to participate in The LTP Program of the instant invention, the Future Home Buyer preferably must first qualify to do so. Following this qualification step, the Future Home Buyer selects or searches for and selects a SFR property. Then the operator of the current invention, The Company, or in some embodiments, a Company Investor (with or without further assistance from The Company), buys the selected SFR property. Then, the Company or the Company Investor leases the SFR property to the Future Home Buyer while providing the Future Home Buyer with a contractual opportunity or option to purchase the SFR property during or immediately after the expiration of the lease period designated by The Company or the Company Investor. During this lease period, in preferred embodiments, the Future Home Buyer resides in the subject SFR property. If and when the Future Home Buyer chooses to purchase said SFR property, the Future Home Buyer exercises their option, thus ending the lease period, and beginning the process of purchasing the property.

In some embodiments, The Company's main or only involvement is to bring together the Company Investor and the Future Home Buyer.

It is not a necessary part of the instant invention that the Future Home Buyer participates in the method of the instant invention by first qualifying for the LTP Program and, second, searching for a SFR. As described herein, the instant invention comprises the steps of the Future Home Buyer selecting a SFR for the LTP Program, and then The Company (or the Company Investor(s)) purchasing this SFR where The Company (or the Company Investor(s)) did not own the SFR property prior to the selection by the Future Home Buyer. Subsequently, the Company or the Company Investor acts as the leasor in the resultant lease option agreement between Future Home Buyer and The Company and/or the Company Investor.

In some embodiments, the instant invention comprises a step wherein The Company works with local real estate agents to advertise The LTP Program. Preferably, local real estate agents are trained by The Company on how The LTP Program works and/or are partnered to market The LTP Program. Other means of advertising The LTP Program to prospective the Future Home Buyer are also contemplated by the instant invention, such as print, internet or infomercial advertising, or as part of financing applications or programs.

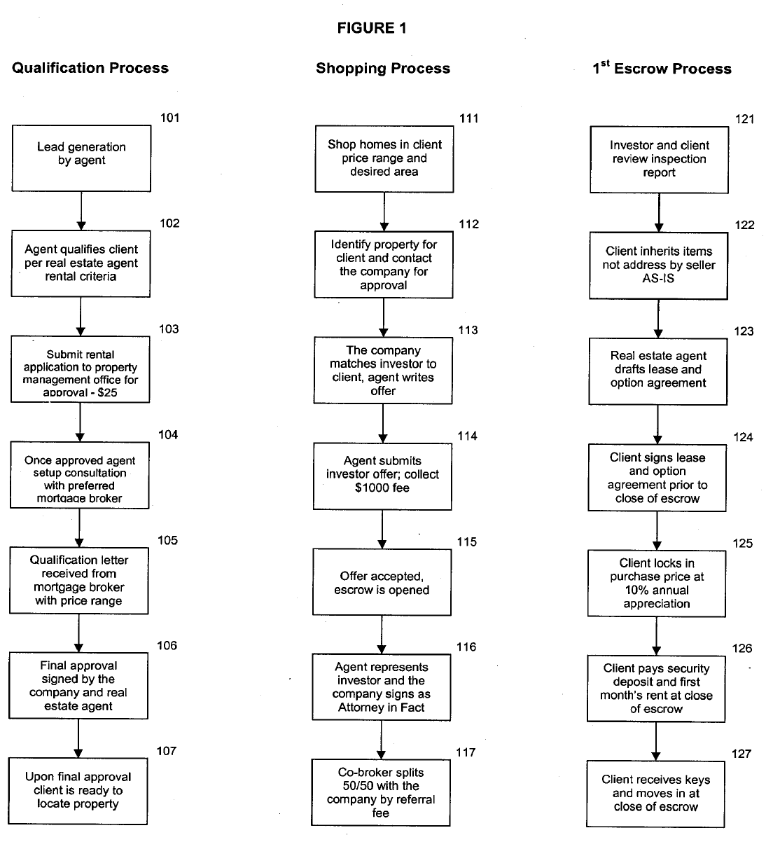

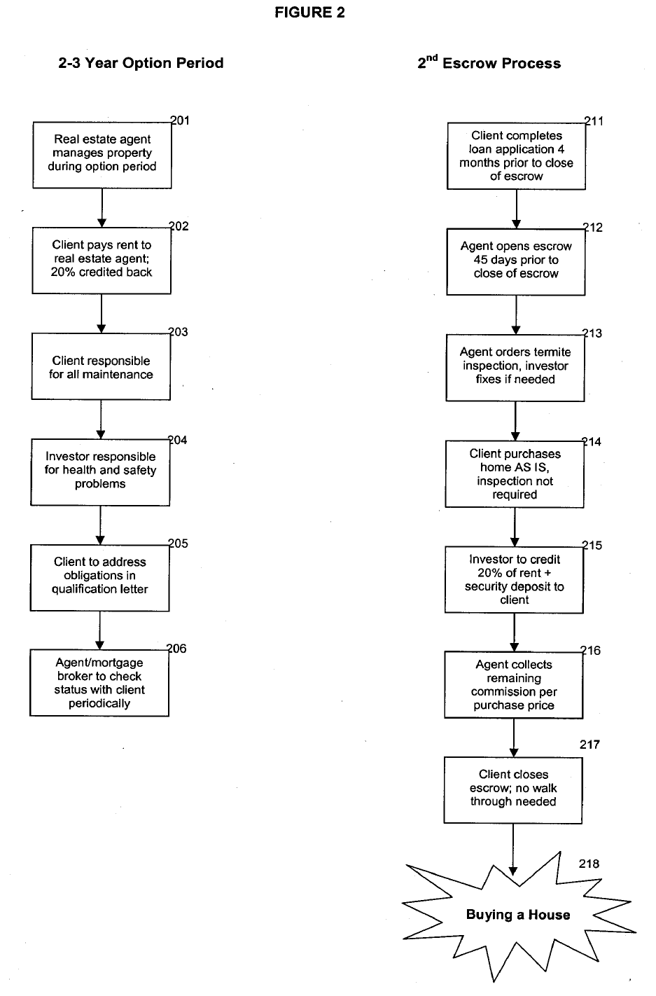

A detailed exemplary overview of the instant invention is provided by FIGS. 1 and 2. It will be recognized by those of skill in the art that FIGS. 1 and 2 are only one example or embodiment of the instant invention; other embodiments of the instant invention may be recognized by reference to FIGS. 1 and 2 and/or the description herein. For example, each of the steps described in FIGS. 1 and 2 may be modified; further, many of the steps are optional so that one or more steps may be eliminated. Also, other steps may be added. Similarly, the order of the steps may be changed or rearranged in numerous ways. Each of these embodiments is within the spirit and scope of the invention as defined by the appended claims. Also, although this embodiment involves C21, other real estate agents may be freely substituted and/or The Company may be directly involved.

(i) Qualification

A prospective Future Home Buyer(s) may contact a participating real estate agent, a participating agent may suggest The LTP Program to a prospective Future Home Buyer 101, or the prospective Future Home Buyer may present his/her/themselves to The Company directly. Once the Future Home Buyer decides to participate or considers participation, in one embodiment, in an initial step of the instant invention The Company attempts to qualify the prospective Future Home Buyer for participation in The LTP Program 102. In preferred embodiments, The LTP Program qualifies the prospective Future Home Buyer using factors that may include one or more of the following: verifying the Future Home Buyer's employment, verifying the Future Home Buyer's capacity to pay the monthly rent plus rental credit, as well as other criteria, such as standard credit checks and verification of employment history(s); but without being limited to just these criteria.

In preferred embodiments, the Future Home Buyer and the real estate agent consult with mortgage banker or broker 104. Based on this consultation, a price range of affordable property for the Future Home Buyer may be determined 105. In general, the monthly payment to be made to The Company or the Company Investor is 0.75% of the price of the SFR while Future Home Buyers are expected to spend up to 30% of their gross income on this monthly payment. Thus, 30% of the Future Home Buyer's gross income should be less than or equal to 0.75% of the SFR's price. The above numbers are to be considered exemplary only and other numbers or values may be used in the instant invention. Thus, the monthly payment could be, in relation to the Future Home Buyer's monthly income: about 50%, about 45%, about 40%, about 35%, about 32%, about 30%, about 28%, about 25%, or less.

One reason a Future Home Buyer may wish to participate in The LTP Program is that certain underwriting risk items may prevent this Future Home Buyer from qualifying outright for a home loan for the SFR in question. One means of evaluating the underwriting risk of Future Home Buyers is the Fannie Mae desktop underwriting program. These road blocks of underwriting risk(s) that prevent the Future Home Buyer from qualifying for a home loan for the property in question at the beginning of The LTP Program may be correctable during the lease period or after the Conversion Point and/or during the final escrow and thus the Future Home Buyer may benefit because of the instant invention. One example of such a risk factor might be a required two year employment history for obtaining a loan. Thus, recent college graduates (including doctors and attorneys) may have excellent career prospects, but lack the necessary employment history and thus are barred from obtaining a loan, at least in the traditional market. Such a Future Home Buyer might be an excellent candidate for The LTP Program. Other potential beneficiaries of the instant invention might be those from a cultural background that handle many transactions on a cash basis and thus individuals may not have an established income and/or savings track record (i.e., seasoned money). Also, a Future Home Buyer's peer group may have little experience in home buying and thus provide little guidance, information, or encouragement 107.

(ii) Select the Property

In a unique feature of preferred embodiments of the instant invention, the Future Home Buyer selects or locates the property that is to be the subject of the lease option 111, 112. The property is purchased by The Company (or a Company Investor) then leased to the Future Home Buyer for a predetermined time or range of times as determined by agreement, referred to herein as the lease period together with the Conversion Point and the following escrow period.

If the prospective Future Home Buyer qualifies for The LTP Program but doesn't have an agent, the Future Home Buyer may be placed with an agent participating in The LTP Program. The prospective Future Home Buyer may proceed with this agent to look for a property for sale in the desired locality presumably within the price range as qualified by The LTP Program 111.

When the property has been selected or located by the Future Home Buyer, in preferred embodiments the identity of the property is submitted to The Company for a final approval to verify that the SFR is suitable for use in The LTP Program 112. In preferred embodiments, The Company bases its decision for approval on factors that include the age of the property, and the state of upkeep, i.e., little deferred maintenance. In preferred embodiments, The Company refers a Company Investor associated with The Company to the Future Home Buyer 113, and the Company Investor(s) buys the SFR property and leases the SFR property to the Future Home Buyer under the terms of the LTP Program. In other preferred embodiments, The Company buys the SFR property and transfers it to a Company Investor(s) who in turn leases the SFR property to the Future Home Buyer under the terms of the LTP Program. In still other preferred embodiments of the instant invention, The Company buys the SFR property and leases the SFR property to the Future Home Buyer under the terms of the LTP Program. In some embodiments, the Future Home Buyer pays The Company an Entry of Escrow or other fee 114. In some preferred embodiments, the Entry of Escrow fee is about $1,000, but other amounts are also within the scope of the instant invention, including fees based on the value of the SFR offer or purchase price. In some embodiments, the fee can be added to the final purchase price, or may be omitted entirely. In some preferred embodiments, this amount is fully, or partially, refundable if escrow fails to close.

Financing is structured around the property in question and the Company or the Company Investor using loan structures known to those of skill in the art. Thus the loan may require a 10% down payment, a 20% down payment, or a different down payment. In some preferred embodiments, the loan is a variable rate loan, but may also be a fixed rate loan. In some embodiments, the loan may be a 30 year fixed rate loan. In preferred embodiments, the loan is a three to five year interest only loan. In other preferred embodiments, the Company Investor is an LLC or a corporation and commercial financing will be used; in some instances this commercial financing will be for a period of up to and including five years. In still other preferred embodiments, the Company Investor will invest in and purchase the SFR in question directly, without the use of a loan.

Thus, in preferred embodiments, the Future Home Buyer selects the SFR property and the financing of the purchase is arranged by The Company, either directly or indirectly through a Company Investor(s).

(iii) Enter First Escrow

As part of the invention, an operator of the instant invention, or an agent thereof, makes an offer on the house 114. In some preferred embodiments, the Future Home Buyer participates in determining the price offered for the house. In some preferred embodiments, the operator of the instant invention presents an all cash offer and/or a non-contingent offer.

If the offer is accepted 115, escrow opens and proceeds as per current laws and procedures in the state and community where the property is located. The LTP contact may be signed by the agent representing The Company and/or the Company Investor, and the Future Home Buyer signs as the attorney in fact 116.

In preferred embodiments, the normal brokerage fee is negotiated between the real estate agent and The Company and/or the Company Investor. Part of the brokerage fee may go directly to The Company. Part of the brokerage fee paid to the real estate agent and/or The Company may be paid upon the first purchase of the SFR and the remainder may be deferred until the FBH purchases the SFR at the end of the LTP Program 117.

A unique feature of preferred embodiments of the instant invention is that the Future Home Buyer participates in the escrow process and must sign off on the inspection process 121, as the Future Home Buyer will, in preferred embodiments, buy the house “as is” following the Future Home Buyer's close of escrow after the Conversion Point of the instant invention 122 & 214.

In preferred embodiments, prior to the close of the first escrow, the Future Home Buyer signs both the lease and the option 123 & 124, which may be separate or integrated documents. Appreciation is locked in at about 10% annual appreciation 125. Other appreciations are contemplated by the instant invention, such as 8%, about 8%, 9%, about 9%, 10%, 11%, about 11%, 12%, about 12%, 13, about 13%, 14%, about 14%, 15%, and about 15%. In some embodiments, the appreciation may be other values, variable and/or set by contract.

In preferred embodiments, the Future Home Buyer prepays one month's rent plus a security deposit 126 and takes possession of the property 127. If a security deposit is prepaid, it may be refunded to FBH at the close of escrow following the Conversion Point. The monthly payment may be set at a percentage of the purchase price, e.g., 0.75% of the purchase price, of which a percentage, e.g., 20%, is Purchase Credit to be applied to down payment, closing costs, and/or other costs. The monthly payment may also be set at about 0.75%, about 0.73%, about 0.71%, about 0.69%, about 0.77%, about 0.79%, or about 0.81% of the purchase price.

The Future Home Buyer may exercise their option to proceed to the Conversion Point during or after a lease period established by The Company or Company Investor. In some preferred embodiments, the Conversion Point occurs at about 2 years. In other preferred embodiments, the Conversion Point occurs at about 20 months. In further preferred embodiments, the Conversion Point occurs at about 3 years. In still further preferred embodiments, the Conversion Point occurs at about 32 months. In other preferred embodiments, the Conversion Point occurs at about 1 year. In still further preferred embodiments the Conversion Point occurs at about 1 month following the end escrow. The Conversion Point is defined as being when the Future Home Buyer begins to exercise her/his/their option to buy the housing property under the lease option contract.

As outlined above, The Company, or the Company Investor, together with the Future Home Buyer, proceed through standard checkpoints in escrow in the state wherein the property is located. In preferred embodiments, at close of escrow, the Future Home Buyer participates, and more preferably approves the purchase, in the final walk through.

In preferred embodiments, the Future Home Buyer's interest in the property is recorded.

(iv) Lease Period; Exercise of Option to Buy; Conversion Point

In some embodiments, during the lease period and up to the final closing, the property is managed by The Company or the Company Investor 201, although in some embodiments The Company (or the Company Investor) may manage the property with the assistance of the participating real estate agent(s). The monthly payment is paid to The Company or the Company Investor (in some embodiments, through an agent such as a participating real estate agent(s)) and the Purchase Credit is held as credit for the close of escrow following the Conversion Point 202. During the lease period and up to the final closing, the Future Home Buyer is preferably responsible for all maintenance to the property 203 except that The Company (or Company Investor) is responsible for correcting all health and safety issues that may arise 204 in accordance with applicable laws.

In preferred embodiments, during the lease period and up to the final closing, The Company (or the Company Investor), acting through the associated real estate agent(s) in some of these preferred embodiments, works with the Future Home Buyer to find a financing partner (e.g., a mortgage banker) to fund the Future Home Buyer's home loan after the Conversion Point. This may be the same financing partner consulted as described above in obtaining a estimate of affordable property for the Future Home Buyer prior to the housing search (see, e.g., 104). In some embodiments, the financing partner may coordinate with the Future Home Buyer to improve the Future Home Buyer's standing under traditional lending guidelines to increase the likelihood that the loan will be fundable at the close of escrow following the Conversion Point. This includes, in preferred embodiments, a timeline delivered to the Future Home Buyer that includes various milestones to be met to better satisfy underwriting considerations 205. During this period, The Company, the Company Investor, or the mortgage broker and/or banker, or in preferred embodiments, the real estate agent(s) acting for The Company, checks the status of the Future Home Buyer's compliance and/or progress periodically 206.

If the Future Home Buyer fails to qualify to purchase the property before the expiration of the lease option, or chooses not to exercise the option, the Future Home Buyer and The Company or the Company Investor have several choices. The Future Home Buyer may re-negotiate the lease option, become a standard tenant(s), move out and find another lease option property, or move out and terminate all connection with The Company and/or Company Investor. These terms are preferably set by contract in the original agreement. If vacated, the property may be sold on the open market or offered with a lease option to another tenant.

When the Future Home Buyer meets the milestones during the lease period and up to the final closing and is thus able to buy the property from The Company or Company Investor, their Purchase Credit held by The Company or the Company Investor (or agent) is credited towards some aspect of the SRF purchase by the Future Home Buyer. In preferred embodiments, the portion of the Future Home Buyer's monthly payment to The Company, the Purchase Credit, that goes towards the house purchase at the Conversion Point is about 20%. In other preferred embodiments, the Purchase Credit may be equal to 10%, about 10%, 11%, about 11%, 12%, about 12%, 13%, about 13%, 14%, about 14%, 15%, about 15%, 16%, about 16%, 17%, about 17%, 18%, about 18%, 19%, about 19%, 20%, about 20%, 21%, about 21%, 22%, about 22%, 23%, about 23%, 24%, about 24%, 25%, about 25%, 26%, about 26%, 27%, about 27%, 28%, about 28%, 29%, about 29%, 30%, or about 30%.

When the Future Home Buyer purchases the house, at the close of the Buyer's escrow following the Conversion Point, in preferred embodiments, credit from the monthly payment to The Company or Company Investor is structured as a seller credit at the time of exercise.

Thus, in part, permanent financing may be secured with the credit from the monthly payment to The Company or Company Investor (this credit is used as a down payment or towards closing costs). In some embodiments, real estate agents are paid from this Purchase Credit or other funds available at close of escrow.

In preferred embodiments, the Future Home Buyer completes the loan application four months prior to the close of escrow following the Conversion Point 211. Other periods are also contemplated by the instant invention. The Future Home Buyer enters the final escrow, where an about forty-five day escrow is a preferred embodiment of the instant invention 212. Other escrow periods are contemplated by the instant invention such as about thirty days or about sixty days. A termite inspection is ordered as per normal laws and procedures of escrow; The Company and/or The Company Investor repairs and/or treats for termite damage as required by the report in most embodiments 213. Other inspections and requirements required by law in the appropriate jurisdiction are also conducted and/or satisfied. In some embodiments, the final home inspection is not conducted; the Future Home Buyer acquires the property based on the first home inspection report during the first escrow 214. Then the Future Home Buyer buys the SFR property from the operators of the instant invention, The Company, (and/or the Company Investor), using in part the Purchase Credit. The participating real estate agent, in some embodiments, collects the remaining commission from the final purchase price 216. In some preferred embodiments, the final walk through is not conducted since the Future Home Buyer, now the purchaser, has been resident in the property for the lease period and up until the final closing 217. Following the close of escrow, the FBH becomes the home owner 218.

In the invention described herein, lease options are used in a flexible manner and to deliver home ownership, rather than just being an inducement to rent. Although lease-to-buy arrangements are well known in the art, the instant invention provides the only example where the Future Home Buyer selects the SFR to buy, secures a financing partner prior to or after selecting the SFR, and where then the financing partner, e.g., The Company or the Company Investor, steps in to buy the property and preferably becomes the owner during the lease period while leasing the SFR property to the Future Home Buyer under the terms of a lease option. This gives a much wider selection of SFR housing property to the prospective Future Home Buyer and markedly broadens the property available to prospective Future Home Buyers.

In the instant invention, the negotiation and execution of the LTP contract and Purchase Credit takes place at arm's length and the Future Home Buyer may select from numerous properties available in a given market where the LTP Program is operating. This distinguishes the instant invention from other situations where a family member(s) assists one another in buying property; thus, there is no familial relationship or the like between the Future Home Buyer and The Company. Similarly, the instant invention is a method of doing business and is distinguished from and does not encompass isolated or single-transaction lease-option arrangements where a benefactor, patron, good Samaritan, legal guardian, or employee of a dramatic production such as a television show assists a Future Home Buyer in the purchase of a SFR through a lease-option arrangement.

(c) The Instant Invention as a Commercial Enterprise

The instant invention also contemplates operating a commercial enterprise based on the methods described herein. As known to one of skill in the art, commercial enterprises can take many forms, including LLCs, partnerships, corporations, and others.

(i) Typical Uses for and Benefits of Lease Options

As noted above, lease options have been used to attract tenants to rent their properties already owned by the leasor. Often, the lease option is merely used as an enticement, albeit an effective one, to persuade tenants to rent the landlord's property, with the rent structured and/or the client selected in such a manner as to make it unlikely that the property is eventually transferred to the renter. As a consequence, significant negative stigma is associated with some lease options when used to take advantage of individuals who probably will not be able to purchase the property and/or have credit problems. Generally in the art to the extent they are known, lease options are offered by small individuals or by local “mom and pop” operations, and are not nationally developed. In contrast, with the instant invention, the investors may not live in the state where the property is located.

In the instant invention, The Company may develop a lease-to-purchase program (LTP Program) on the national level.

In one aspect, the instant invention includes several new financing vehicles for home purchases (LTP Program transaction types) as well as value added services (credit counseling, savings programs) to help working families, and other qualified participants, own a piece of the American Dream (home ownership). The instant invention is also a new type of real estate investment fund which enables individuals and institutions to make passive investments in high-growth Single Family Residential (SFR) markets.

The operator of the instant invention may optionally provide the access, knowledge and execution capabilities to facilitate a portfolio of non-local SFR real estate investments for an investor. In preferred embodiments, the operator of the instant invention's unique end-to-end solution allows potential investors to avoid the time consuming difficulties of acquisition, management, and the eventual sale of property. In preferred embodiments, the operator of the instant invention, e.g., The Company, manages most or all aspects of the investment process including:
(1) local market expertise & research;
(2) exclusive property identification channels;
(3) on-site due diligence;
(4) innovative financing;
(5) secured tenant revenue guarantee;
(6) full-service property management (tenant qualification, property maintenance, payment processing); and
(7) client driven profit realization (structured asset sales to meet financial objectives).

In preferred embodiments, the instant invention provides a liquid real estate investment whereby the prospective investor (Company Investor) can sell a given position at any time. In preferred embodiments, the instant invention provides a full service team of professionals including tax accountants, acquisition personnel, property managers, financial planners, attorneys, and real estate brokers. In some preferred embodiments, the instant invention contemplates specialization and investment primarily or only in SFR properties for the following reasons:

(1) Proportional to investment, SFR real estate provides the most significant return of any real estate class.

(2) SFR properties enable the highest leverage at the lowest cost of capital in the marketplace. In preferred embodiments, the operator of the instant invention targets properties from $140 k-$185 k, or other appropriate values, to provide for conforming, commercial, and blanket loans.

(3) SFR properties potentially provide a hedge against for inflation and devaluation of currency:

(a) Multiple SFR investments enable a geographic diversification with minimal capital outlay;
(b) SFR properties are generally the most liquid of any real estate asset;
(c) the SFR housing market may provide consistent and predictable demand. Thus, in some preferred embodiments, the operator of the instant invention selects specific regions where the predictable population growth will increase the demand for housing; and
(d) depreciation, interest, and other tax benefits are available directly to the investors.

To identify regions for optimal operation of the instant invention, the operator of the instant invention will preferably attempt to find rising real estate markets. As is evident to one of skill in the art, local regional factors significantly influence real estate value. In addition, high growth regions can be identified with respect to the real estate market. As discussed above, rising real estate markets can be associated with:
(1) strong local economic conditions (e.g., areas of job growth, stable/expanding industries, diversified economies, pro-growth initiatives, favorable city/county governments);
(2) a suitable affordability index (i.e., the ratio of regional average incomes to local housing costs);
(3) stable housing prices poised for appreciation (i.e., high growth areas which have not yet experienced hyper-growth or are not in an overly appreciated market);
(4) acceptable home-building-permit to rental-population ratio; and/or
(5) other factors.

(ii) Overview: Investor Income

The investment of the operator of the instant invention may be secured by a secondary market of new home buyers to realize a liquid investment with a lease period that can range in length from a month to five years, but is preferably from one to three years.

Based on the financial objective of the investment portfolio, in preferred embodiments, The Company, the Company Investor and/or the Future Home Buyer determine the lease period. For a short, buy & flip strategy, the operator of the instant invention may have a pool of immediate Company Investors. With a medium (e.g., one to three year) lease period, the operator of the instant invention has Future Home Buyers and buyers to secure a steady stream of cash flow and a set appreciation rate. Also, for a longer term objective, the operator of the instant invention may also have tenants renting or leasing with no option to buy. The operator of the instant invention has the capability to customize the financial instrument to meet several investment objectives and the cash flow/appreciation matrix for the desired financial yield/return as will be appreciated by those of skill in the art.

In general, traditional real estate investors in the SFR market are not interested in investments that have a capped earning realization. In the instant invention operated as described herein, the instant invention may limit the upside potential in return for requiring a smaller investment by the creative and novel use of lease options as described herein.

Preferred embodiments of the instant invention as described above are intended to produce: (1) a steady income to The Company, the Company Investor, and/or an investor in The Company; (2) a motivated tenant (i.e., the Future Home Buyer); and (3) a limit to the cost from holding vacant property that is associated with standard methods of owning or investing in SFR property where one or more houses are owned through a succession of tenants.

The operator of the instant invention (in one embodiment, The Company) also may work with small and medium sized businesses to provide an employee retention program (see, e.g., Example 2).

(iii) The Instant Invention as a REIT

The instant invention also contemplates operating a REIT based on the methods described herein. In certain aspects, the instant invention may be a REIT designed to focus on the SFR market, allowing investors the ability to invest in the stable but growing SFR market. Typically, traditional real estate investors are not interested in investments that have a capped earning realization. In the REIT operated as described herein, The Company may limit the upside potential in return for requiring a smaller investment by the creative and novel use of lease options as described herein.

### EXAMPLES

### (a) Example 1

(1) Selected High-Growth Markets

The operator of the instant invention has identified numerous regions in 2005 that meet high-growth market criteria including affordable housing (as analyzed by comparing median income to median home price), population growth, and employment growth. As of 2005, therefore, the operator of the instant invention expects to operate in the following regions:
Phoenix, Ariz.—fully operational; online May 15, 2004;
Charleston, S.C.—developing market; online: Jan. 31, 2005;
Tallahassee, Fla.—in progress; and
Austin, Tex.—in progress.

### (b) Example 2

A Two Year Cash Flow Directed Portfolio

(2) Beneficial For the Future Home Buyer

An Home Ownership Employee Benefit Program provides a steady stream of yearly returns with a specific exit timeline. This program provides small to medium sized businesses an immediate employee incentive plan. It is similar to a 401K plan; however, it provides the tangible benefit of home ownership. This program is much more than a distant future benefit (e.g., retirement money), it provides the employee the ability to select his/her own home today and own the property in two years. It is a dollar for dollar match system. That is, the employer matches every dollar that the employee provides to the investment.

(3) Beneficial For the Investor

The typical monthly rent in a region is about $1,000. The LTP Program (in this example referred to as the “Home Ownership program”) consists of a $1,500 housing expense, of which $250 comes from the employer and $250 from the employee/future homeowner, plus the un-matched rent of $1,000. Thus, up $750 of the monthly amount may go to the down payment or other fees and/or expenses. After two years, the employee has a 10% down payment on a SFR. The LTP Program also provides permanent financing assistance and consultation. Thus, the employee upon entrance to The LTP Program can immediately select the home that they want to own, live in it, and own it in two years.

The Company (in this specification) may work with a number of small and medium sized businesses in local regions. Such a small to medium sized business may traditionally recruit recent college graduates into their management training program. These recruits may respond much more favorably to such a home ownership employee benefit program than to a traditional 401K benefit. Home ownership and housing also provides a superior retention tool. The tangible benefits of moving into a real home are realized almost immediately upon joining a company offering the home ownership employee with the instant invention as described herein.

### (c) Example 3

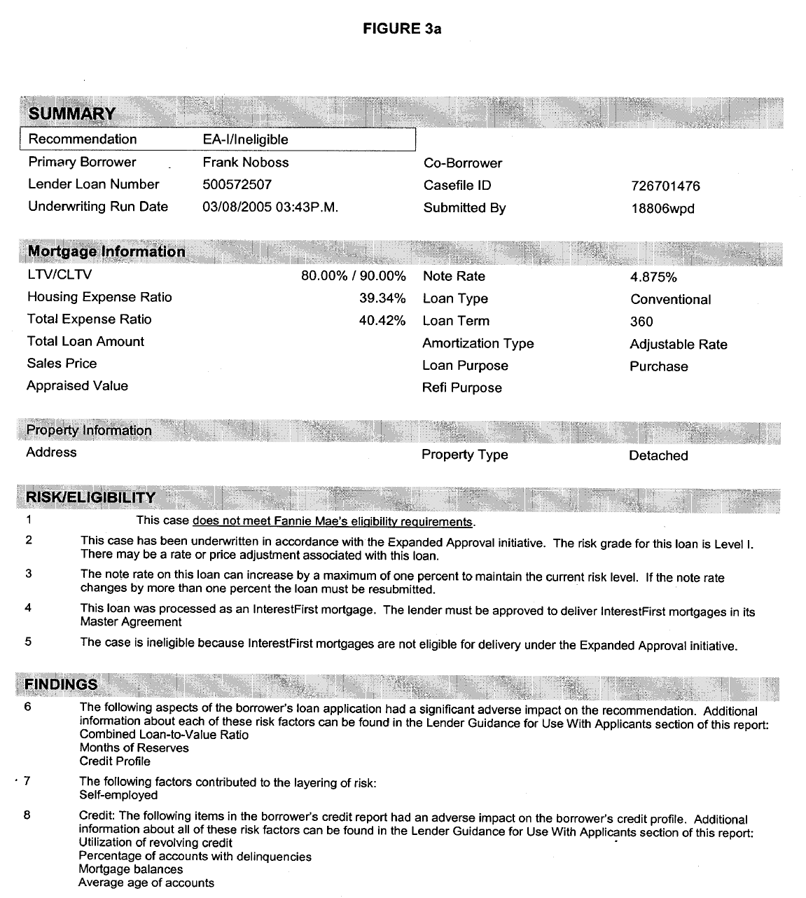

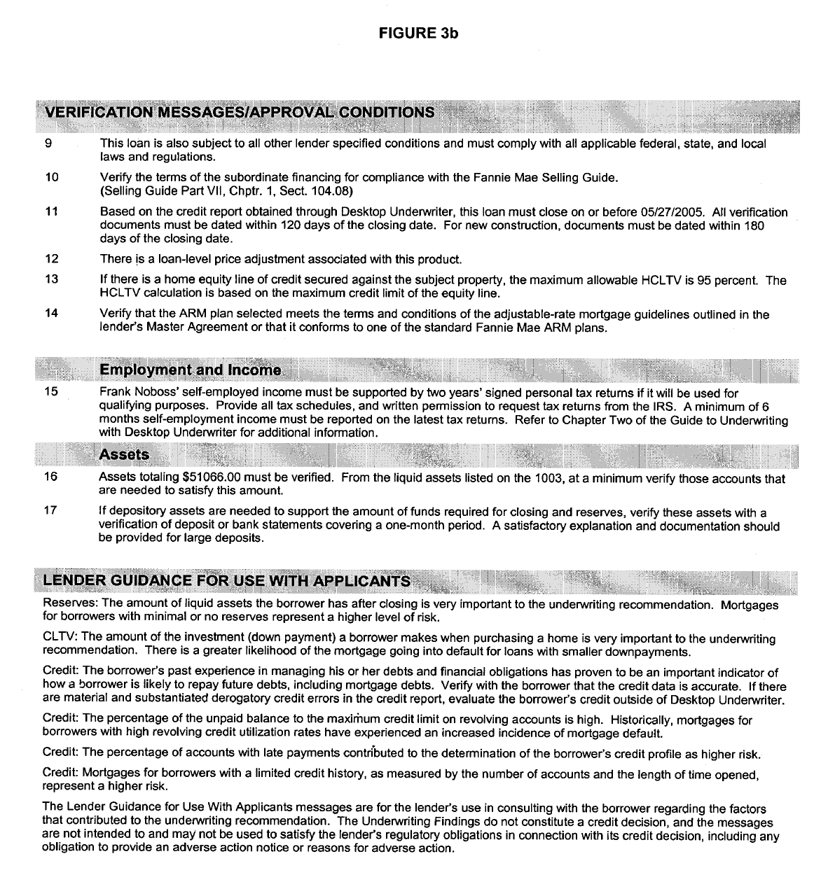

In one example of underwriting guidelines illustrated in FIG. 3, Frank Noboss would like to buy a home. However, Frank Noboss does not qualify for a loan under the Fannie Mae underwriting guidelines. Mr. Noboss was trying to obtain a mortgage-backed loan characterized by a LTV/CLTV ratio of 80.00%/90.00%. The loan was to be an adjustable 30 year loan with an initial interest rate of 4.875%. Frank's housing expense was too high for the underwriting guidelines, at 39.34%, and this total expense ratio, 30.42% was likewise too high. In this example, under current Fannie Mae underwriting guidelines, the following factors had significant adverse impact: (1) the Combined Loan-to-Value ratio, (2) the amount of reserve assets based on Frank's monthly income, and (3) Mr. Noboss' credit profile.

If Frank Noboss were to become a Future Home Buyer with regard to the instant invention, Frank's standing under the Fannie Mae guidelines could be improved with regard to (2) and (3) above during a lease period and up to the final closing. Therefore, under the instant invention, Frank would be expected spend the lease period in improving his reserve assets and his credit profile.

Additionally, Frank Noboss is self-employed. Although the instant invention is not primarily directed to self-employed Future Home Buyers, the program may be modified and made advantageous for them.

Further, Frank Noboss has several items in his credit report that have an adverse impact on Frank's credit profile: (1) he utilizes revolving credit, (2) he has a high percentage of accounts with delinquencies, (3) he has mortgage balances, and (4) the average age of his accounts is too old.

Typical underwriting guidelines require that he provide two years of signed tax returns and written permission to request returns directly from the IRS, as well as six months of self-employment income verification. Further in this example, the underwriting guidelines insist on verification of $51,066 in assets.

Therefore, Frank Noboss is an excellent candidate as a Future Home Buyer for the instant invention. Frank Noboss, before or preferably after he qualifies for LTP Program, may select a SFR and The Company and/or the Company Investor will first purchase the SFR property. Then Frank can lease the SFR property from The Company and/or the Company Investor with some of the rent being set aside for Frank's use, i.e., Purchase Credit, at the expected purchase of the SFR. During the lease period and up until the final close of escrow, Frank can work on correcting the deficiencies in his credit report as outlined above so that he can qualify for a traditional mortgage loan and purchase the SFR property from The Company and/or the Company Investor after the Conversion Point.

The example above was presented as illustration only. In another typical example of a potential Future Home Buyer that doesn't qualify for a loan under standard guidelines, the initial rate loan interest rate is 7.5%, the housing expense value is 39.34%, and the total expense value is 48.3%.

Both these examples are presented for illustration purposes only and are not intended to limit the invention.

### (d) Example 4

In the example below, a hypothetical LLC is formed for investment purposes as a Company Investor and invests in three SFRs, with the capacity to add one or two more using the instant invention. All properties are in or near Phoenix, Ariz. (the addresses and company name have been changed).

SGSW Partners, LLC

| | DOWN PAYMENT | |
|---|---|---|
| | & CLOSING COSTS | TOTAL |
| 1. 4263 College Gardens Ct. | $44,252 | $44,252 |
| 2. 120 W 10th St. | $56,493 | $100,745 |
| 3. 15404 E. Wilshire Ln. | $64,200 | $164,945 |
| 4. TBD | | $164,945 |
| | EARNEST | $10,000 |
| | MONEY FUND | |
| | | BALANCE |
| 1. 4263 College Gardens Ct. | $1,699 | $8,301 |
| POC -Prop Inspection | $305 | $7,996 |
| 2. 120 W 10th St. | $2,500 | $5,496 |
| 3. 15404 E. Wilshire Ln. | $1,000 | $4,496 |
| 4. TBD | | $4,496 |
| | CREDIT FACILITY | $1,050,000 |
| | | BALANCE |
| 1. 4263 College Gardens Ct. | $127,425 | $922,575 |
| 2. 120 W 10th St. | $165,000 | $757,575 |
| 3. 15404 E. Wilshire Ln. | $193,500 | $564,075 |
| 4. TBD | | $564,075 |

1. 1539 4263 College Gardens Ct. (Phoenix) AZ [zip]

| | |
|---|---|
| Purchase Price | $169,900 |
| Lease to Purchase Rate | 0.0075% |
| Loan Amount | $127,425 |
| Interest Rate | 6.51% |
| PMT | $708 |
| Taxes | $75.00 |
| Insurance | $41.67 |
| PITI | $824.27 |
| Management | $75.00 |
| Miscellaneous | $75.00 |
| Income | $1,274.25 |
| NOI | $1,008 |
| Cash Flow | $299.98 |
| Total Unit Cost | $46,256 |
| Annual Yield | 7.78% |

2. 120 W 10th St. (Phoenix) AZ [zip]

| | |
|---|---|
| Purchase Price | $220,000 |
| Lease to Purchase Rate | 0.0075% |
| Loan Amount | $165,000 |
| Interest Rate | 6.74% |
| PMT | $922 |
| Taxes | $114.58 |
| Insurance | $45.83 |
| PITI | $1,082.02 |
| Management | $75.00 |
| Miscellaneous | $75.00 |
| Income | $1,650.00 |
| NOI | $1,340 |
| Cash Flow | $417.98 |
| Total Unit Cost | $58,993 |
| Annual Yield | 8.50% |

3. 15404 E Wilshire Ln. (Phoenix) AZ [zip]

| | |
|---|---|
| Purchase Price | $258,000 |
| Lease to Purchase Rate | 0.0075% |
| Loan Amount | $193,500 |
| Interest Rate | 6.37% |
| PMT | $1,050 |
| Taxes | $134.38 |
| Insurance | $37.75 |
| PITI | $1,222.11 |
| Management | $75.00 |
| Miscellaneous | $75.00 |
| Income | $1,935.00 |
| NOI | $1,613 |
| Cash Flow | $562.89 |
| Total Unit Cost | $65,200 |
| Annual Yield | 10.36% |
| TOTAL INVESTMENT SUMMARY TO DATE | |
| Total Acquisition Cost | $170,449 |
| Net Operating Income | $47,521 |
| Capitalization Rate | 7.3% |
| Debt Service | $32,150 |
| Initial Real Estate Equity | $647,900 |
| Cash Flow | $15,370 |
| Sale Price* | $783,959 |
| Annualized Yield** | 9.02% |

*As set forth in the lease-option agreement based on the total number of properties.
**Incurred and actual expenses to date, Appreciation NOT calculated in Yield.

### (e) Example 5

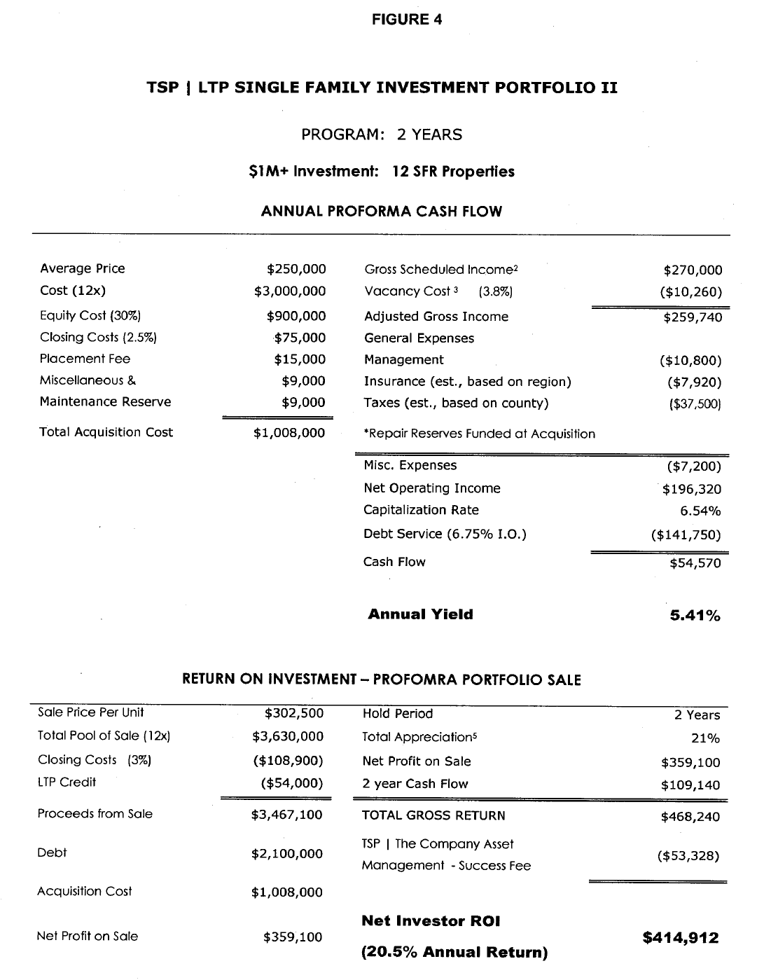

The SFR Property Partners (TSP) is formed in 2005 to serve as a corporate General Partner in a single-family real estate investment partnership. An summary of financial parameters associated with the projected operation of TSP is depicted in FIG. 4. TSP continues to seek capital growth through strategically timed investments and maximize value through aggressive management and asset repositioning. Individual investors participate through company-sponsored partnerships allowing for equity growth via real estate without the risk or overhead on hands-on facilitation.

Our strategic partnership with The Company, a real estate investment firm specializing in single-family lease to purchase (LTP) programs, enables TSP to package single family properties to perform like a multi-family investment with the higher appreciation rates of the single family market. This multi-unit portfolio targets, and anticipates achieving, cash-flow yields of 5-7% and annual returns of 15-20%.

Lease To Purchase

Conventional wisdom for investors in SFRs is to buy a property, then work toward finding a renter. In contrast, every property that will be purchased by TSP is pre-selected by an LTP program Future Home Buyer as the home they want to own, but are currently unable to finance the purchase by acquiring a loan. TSP purchases these properties while simultaneously entering a 2-year LTP contract with the Future Home Buyers.

LTP Program Future Home Buyers pay a market competitive rent for the house plus a “premium” each month for the option to purchase the property at a pre-contracted price. This financial structuring serves to secure the investment in two key areas: mitigating vacancy and increasing cash flow. At the end of the lease period, if the Future Home Buyer exercises an option to purchase the SFR property, the total of the “premium” payments are credited back to the Future Home Buyer and may be used as part of the down payment for the home purchase. If the Future Home Buyer cannot or decides not to purchase at the end of the lease period, the “premium” payments are forfeited and/or other arrangements are made.

The LTP Program of the instant invention enables some of these families to realize homeownership while securing a high return, short term real estate investment for investors. TSP is targeting Future Home Buyer applicants that reasonably qualify for permanent financing within a two year period.

Future Home Buyer Profile:

(1) Recent college graduates who cannot qualify for conventional financing due to the two year employment requirement.

(2) Families with stable employment but no credit history or asset seasoning.

(3) Working families requiring budgetary assistance to qualify as a home buyer.

Markets

TSP operates with The Company in the Phoenix, Ariz. area where steady population growth and a strong local job market are leading to an ongoing shortage of homes and enabling TSP's ability to realize capital growth. Other markets of interest that meet similar high-growth criteria (i.e. affordable housing, sustainable population growth, and accelerating employment growth) are: Charleston, S.C.; Austin, Tex.; and Jacksonville, Fla.

The invention illustratively described herein can suitably be practiced in the absence of any element or elements, limitation or limitations that is not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalent of the invention shown or portion thereof, but it is recognized that various modifications are possible within the scope of the invention claimed. Thus, it should be understood that although the present invention has been specifically disclosed by preferred embodiments and optional features, modifications and variations of the inventions embodied herein disclosed can be readily made by those skilled in the art, and that such modifications and variations are considered to be within the scope of the inventions disclosed herein. The inventions have been described broadly and generically herein. Each of the narrower species and subgeneric groupings falling within the generic disclosure also form the part of these inventions. This includes within the generic description of each of the inventions a proviso or negative limitation that will allow removing any subject matter from the genus, regardless or whether or not the material to be removed was specifically recited. In addition, where features or aspects of an invention are described in terms of the Markush group, those schooled in the art will recognize that the invention is also thereby described in terms of any individual member or subgroup of members of the Markush group. Further, when a reference to an aspect of the invention lists a range of individual members, as for a non-limiting example, ‘the letters A through F, inclusive,’ it is intended to be equivalent to listing every member of the list individually, that is ‘A, B, C, D, E and/or F,’ and additionally it should be understood that every individual member may be excluded or included in the claim individually. Additionally, when a reference to an aspect of the invention lists a range of individual numbers, as for a non-limiting example, ‘0.25% to 0.35%, inclusive,’ it is intended to be equivalent to listing every number in the range individually, and additionally it should be understood that any given number within the range may be included in the claim individually.

The steps depicted and/or used in methods herein may be performed in a different order than as depicted and/or stated. The steps are merely exemplary of the order these steps may occur. The steps may occur in any order that is desired such that it still performs the goals of the claimed invention. In particular, the Future Home Buyer can begin participation in the LTP Program before this Future Home Buyer selects a SFR, or the Future Home Buyer can select the SFR and elect to participate in the Program as a means to acquire the SFR. In addition, although the The Company, Investor or Company Investor may be referred to herein as selecting an investor, The Company, Investor or Company Investor may be passive in the selection process except for advertising the LTP Program and/or qualifying a potential Future Home Buyer under the LTP Program, and allow the Future Home Buyer to find and contact the The Company, Investor or Company Investor.

From the description of the invention herein, it is manifest that various equivalents can be used to implement the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are considered in all respects as illustrative and not restrictive. It should also be understood that the invention is not limited to the particular embodiments described herein, but is capable of many equivalents, rearrangements, modifications, and substitutions without departing from the scope of the invention. Thus, additional embodiments are within the scope of the invention and within the following claims.

What is claimed is:

1. A method for a Future Home Buyer to reside in a single family residence comprising the steps of:
said Future Home Buyer selecting said single family residence (SFR) that is for sale;
said Future Home Buyer directing a third party to purchase said SFR;
said third party purchasing said SFR; and
said third party leasing said SFR to said Future Home Buyer for a lease period; wherein
said Future Home Buyer has an option to purchase said SFR from said third party after said lease period.

2. The method of claim 1 wherein said third party is selected from the group consisting of a The Company; a Company Investor, and a REIT.

3. The method of claim 1 wherein said Future Home Buyer exercises said option to purchase said SFR after said lease period and purchases said SFR.

4. The method of claim 3 wherein said SFR's price after said lease period is related to said SFR's price when purchased by said third party by an appreciation rate determined by contract.

5. The method of claim 1 wherein said Future Home Buyer pays to said third party a monthly payment wherein a percentage of said monthly payment is set aside as a Purchase Credit after said lease period, and wherein when said Future Home Buyer finances said Future Home Buyer's purchase of said SFR said Purchase Credit is used for a purpose selected from the group consisting of paying all or part of a down payment, paying all or part of said Future Home Buyer's closing costs, paying said Future Home Buyer's real estate agent's commission, and paying any cost associated with an escrow following a Conversion Point.

6. The method of claim 1 wherein said Future Home Buyer's interest in said SFR is recorded against said SFR's title.

7. A method for an investor to invest in a SFR comprising the steps of:
selecting a Future Home Buyer;
said Future Home Buyer selecting a SFR for sale;
said investor buying said SFR;
said investor leasing said SFR to said Future Home Buyer for a lease period, and
said Future Home Buyer having an option to purchase said SFR from said investor after said lease period.

8. The method of claim 7 wherein said investor is selected from the group consisting of a The Company; a Company Investor; and a REIT.

9. The method of claim 7 wherein said Future Home Buyer exercises said option to purchase said SFR at the end of said lease period and purchases said SFR.

10. The method of claim 7 wherein during said lease period, said Future Home Buyer pays to said investor a monthly payment, wherein a percentage of said monthly payment is set aside as a Purchase Credit, and wherein when said Future Home Buyer finances said Future Home Buyer's purchase of said SFR said Purchase Credit is used for a purpose selected from the group consisting of paying all or part of a down payment, paying all or part of said Future Home Buyer's closing costs, paying said Future Home Buyer's real estate agent's commission, and paying any cost associated with an escrow following a Conversion Point.

11. The method of claim 7 wherein said SFR's price paid for by said third party is related to said SFR's price paid by said Future Home Buyer for said SFR by an appreciation rate determined by contract.

12. A method for one or more investors to invest in a SFR comprising the steps of:
selecting a plurality of Future Home Buyers to participate in a LTP Program;
each of said plurality of Future Home Buyers selecting a corresponding SFR that is for sale;
said one or more investors purchasing said each corresponding SFR for each Future Home Buyer of said plurality of Future Home Buyers;
said one or more investors leasing each of said corresponding SFRs to each of said Future Home Buyers for a lease period, and
each of said Future Home Buyers having an option to purchase said SFR from said investor after said lease period.

13. The method of claim 12 wherein said one or more investors is selected from the group consisting of a The Company, a Company Investor, and a REIT.

14. The method of claim 12 wherein during said lease period of each of said corresponding SFRs by each of said Future Home Buyers, a part of each of said Future Home Buyers' monthly payment is individually set aside as a Purchase Credit to that Future Home Buyer when said Future Home Buyer purchases said SFR, and wherein when each individual Future Home Buyer finances said Future Home Buyer's purchase of said individual SFR said individual Future Home Buyer's Purchase Credit is used for a purpose selected from the group consisting of paying all or part of a down payment, paying all or part of closing costs, paying said Future Home Buyer's real estate agent's commission, and paying any cost associated with an escrow following a Conversion Point.

15. The method of claim 12 wherein one of said Future Home Buyers exercises said option to purchase said corresponding SFR in which said Future Home Buyer resides at the end of said lease period.

16. The method of claim 15 wherein each of said SFRs' price paid by said one or more investors is related to said SFR's price paid by each corresponding Future Home Buyer of said plurality of Future Home Buyers for said SFR in which said Future Home Buyer resides by an appreciation rate determined by contract.

17. The method of claim 12 wherein each of said Future Home Buyers' interests in each said corresponding SFR is recorded against said SFR's title.

18. The method of claim 1 wherein the instant invention is advertised by a method selected from the group consisting of print advertisements, audio advertisements, and visual advertisements.

19. The method of claim 7, wherein the instant invention is advertised by a method selected from the group consisting of print advertisements, audio advertisements, and visual advertisements.

20. The method of claim 12 wherein the instant invention is advertised by a method selected from the group consisting of print advertisements, audio advertisements, and visual advertisements.
